(19) United States
(12) Patent Application Publication
(10) Pub. No.: US 2011/0101181 A1
(43) Pub. Date: May 5, 2011

(54) LIGHTING FIXTURE ACCESSORY AND METHODS OF USE

(76) Inventors: Edward Darrell Jervey, III, Richmond, VA (US); Bobby D. Mills, Houston, TX (US); Steven C. Machiorlette, Houston, TX (US)

(21) Appl. No.: 12/916,118

(22) Filed: Oct. 29, 2010

Related U.S. Application Data
(60) Provisional application No. 61/256,681, filed on Oct. 30, 2009.

(51) Int. Cl. F16M 13/02; B32B 3/06; B23P 11/00

(52) U.S. Cl. 248/205.1; 428/99; 428/100; 29/428

(57) ABSTRACT

Methods and apparatus for adding a decorative accessory to a hanging light fixture are provided. The accessory comprises at least a first part and a second part of a decorative accessory. The at least the first part and the second part are configured for placement together around a hanging support member of a hanging light fixture without having to thread the hanging support member through the decorative accessory. At least one attachment mechanism is configured to secure the first part and the second part together around the hanging support member.

The present application for patent claims benefit of U.S. Provisional Patent Application Ser. No. 61/256,681 filed Oct. 30, 2009, entitled, “Lighting Fixture Accessory” which is hereby expressly incorporated by reference herein.

### BACKGROUND OF THE INVENTION

Property owners often are interested in improving the appearance of the interior space of their building. Adding or modifying light fixtures is a common way to improve the appearance of a space. For example a homeowner may wish to add decorative lighting in the form of a hanging light fixture to improve the value of the home or to change the ambience of a room. Furthermore, a homeowner may wish to change features of an existing hanging light fixture, for example, to decorate according to seasonal changes or to keep with current decorating trends.

Currently, however, the only way of adding or changing decorative elements, enhancements, accessories, or the like to existing hanging light fixtures is to remove the fixture so that the accessory can slide over and down the cord, wire or chain. However, the step of removing the fixture, adding the accessory, and then re-hanging the fixture is difficult, time consuming and in some cases not even possible because of encumbrances along the cord, wire, rod or chain. Moreover, a professional electrician may be required, which is costly.

Thus, there is need for a decorative accessory which can be easily attached to, and removed from, a hanging light fixture without detaching or disconnecting the hanging fixture from its installed, finished position. Furthermore, there is a need for a hanging light fixture that allows for ready attachment or replacement of decorative accessories without detaching or disconnecting the hanging fixture from its finished position. Furthermore, there is a need for a method for easily attaching and/or removing a decorative accessory from a hanging light fixture without detaching or disconnecting the hanging fixture from its finished position.

### SUMMARY OF THE INVENTION

Embodiments of the present invention generally relate to a decorative accessory for a hanging light fixture.

In one embodiment, an accessory for a hanging light fixture is provided. The accessory comprises at least a first part and a second part of a decorative accessory. The at least the first part and the second part are configured for placement together around a hanging support member of a hanging light fixture without having to thread the hanging support member through the decorative accessory. At least one attachment mechanism is configured to secure the first part and the second part together around the hanging support member.

In another embodiment, a method for decorating an existing hanging light fixture suspended from a ceiling is provided. The method includes the step of positioning a decorative accessory around a hanging support member of the hanging light fixture while the hanging light fixture remains suspended from the ceiling by the hanging support member. The method further includes the step of securing the decorative accessory around the hanging support member with at least one attachment mechanism.

In yet another embodiment, an accessory for a hanging light fixture is provided. The hanging light fixture for which the accessory is provided has a hanging support member providing an electrical connection to a light socket, the light socket hanging from a lower end of the hanging support member while an upper end of the hanging support member is attached to a ceiling. The accessory comprises an assembly configured to be removably disposed around the hanging support member without disassembling any portion of the hanging light fixture. The accessory further comprises a top connection piece configured to be disposed around the hanging support member and configured to removably secure the assembly around the hanging support member without disassembling any portion of the hanging light fixture.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. In fact, it will be apparent to those skilled in the art that various modifications and variations can be made in the present invention without departing from the scope or spirit of the invention. Thus, it is intended that the present invention cover such modifications and variations as come within the scope of the appended claims and their equivalents.

FIG. 1A illustrates a hanging light fixture usable with a removable accessory according to an embodiment of the present application.

FIG. 1B-1C illustrates a hanging light fixture with a removable accessory according to an embodiment of the present application.

FIGS. 1D-1E illustrate aspects of a removable accessory for use with a hanging light fixture according to an embodiment of the present application.

FIG. 2A illustrates a hanging light fixture with a removable accessory according to an embodiment of the present application.

FIG. 2B illustrates aspects of a removable accessory for use with a hanging light fixture according to an embodiment of the present application.

FIG. 3 illustrates a hanging light fixture with connector parts for a removable accessory (not shown) according to an embodiment of the present application.

FIGS. 4A-4D illustrate a hanging light fixture with a removable accessory according to an embodiment of the present application.

FIGS. 5A-5B illustrate a removable accessory for attaching to a hanging light fixture according to an embodiment of the present application.

FIG. 6 illustrates a removable accessory for attaching to a hanging light fixture according to an embodiment of the present application.

FIGS. 7-8 illustrate a removable accessory and connector parts according to an embodiment of the present application.

FIGS. 9A-9C illustrate a removable accessory for attaching to a hanging light fixture according to an embodiment of the present application.

### DETAILED DESCRIPTION

The present application relates to a hanging light fixture, including but not limited to a pendant light or a chandelier.

More specifically, the present application relates to a decorative accessory that can be readily attached to and removed from a hanging light fixture without removing the hanging light fixture from its installed, finished position. In other words, the hanging light fixture does not have to be detached or disconnected in any way from its finished position in order to attach or remove the decorative accessory. No special tools, experience or expertise is required to attach the decorative accessory to the hanging light fixture.

When attached to the hanging light fixture, the decorative accessory looks permanent but is actually removable. The decorative accessory can include any type of decorative features. For example and without limitation, the decorative accessory may include one or more decorative elements such as a swirl, scroll, ball, rod or the like. The decorative accessory may be placed around a hanging support member, such as a cord, of the hanging light fixture to form a decorative shape. The hanging support member may be a cord, wire, chain, rod or the like, from which the hanging light fixture is suspended from the ceiling. The decorative accessory may add flexible rigidity, such as with a flexible metal coiled tube around the cord, so that the cord can be bent into a unique decorative and/or useful position and retain such position while the light fixture remains suspended.

In at least one embodiment, the decorative accessory covers and/or attaches to at least a portion of the hanging support member—i.e., cord, wire, chain, rod or the like—from which the hanging light fixture is suspended. In other embodiments, the decorative accessory may cover and/or attach to another part of the light fixture, such as an arm, rod, lamp cup or ceiling medallion. It is further contemplated that, in certain embodiments, the decorative accessory may cover and/or attach to one or more lighting elements of the hanging light fixture, such as a light bulb socket assembly or a shade. In certain embodiments, the hanging light fixture may be specially configured for mounting the decorative accessory. In other embodiments, the decorative accessory may be configured for mounting to a conventional hanging light fixture.

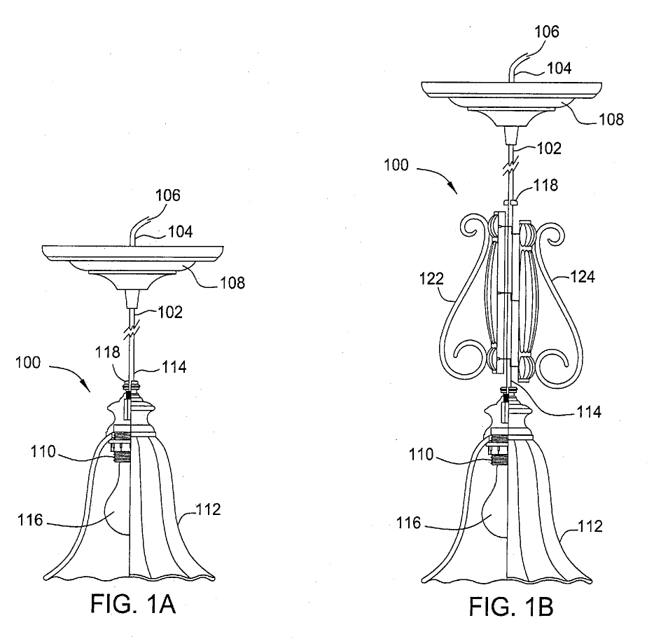

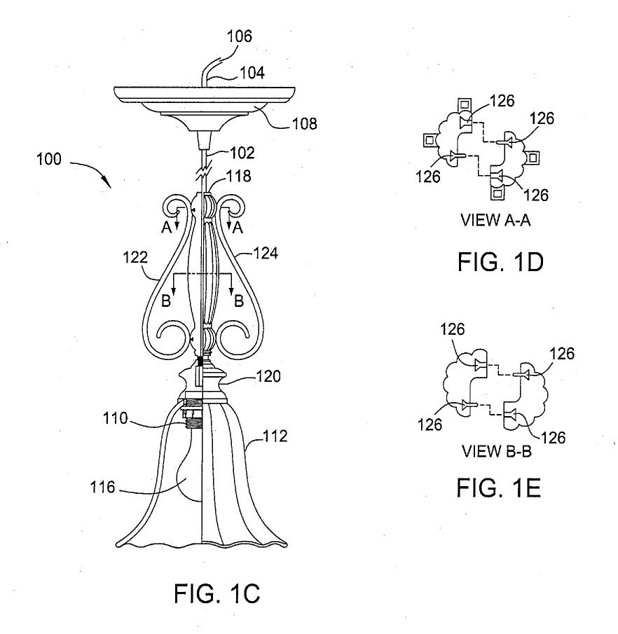

In FIGS. 1A, 1B, 1C, 2A, and 3 a hanging light fixture 100 is provided. The hanging light fixture 100 includes a cord 102. The upper end of the cord 104 includes one or more connections 106 to a source of electric power in the ceiling (not shown). The connection 106 can be any type of connection to a source of electric power. The cord 102 passes through a ceiling medallion 108. A light bulb socket 110 is connected to the lower end of the cord 114 completing an electrical connection to illuminate light bulb 116, as desired. Shade 112 is affixed to the socket 110 in a conventional manner.

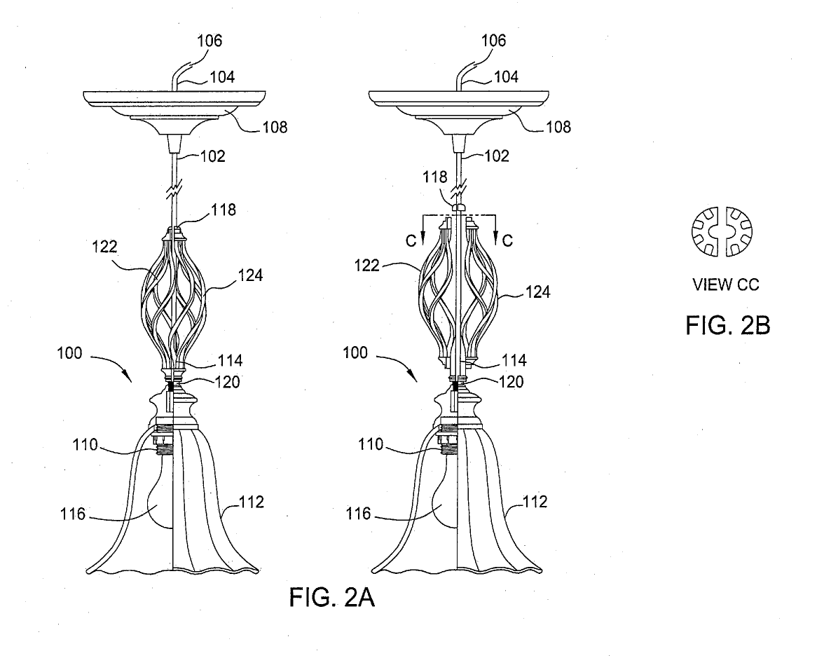

When it is desired to add a decorative accessory to the hanging light fixture 100, a first accessory part 122 and a second accessory part 124 are placed together around cord 102. Although two accessory parts are shown in FIGS. 1B and 2A, the decorative accessory may be comprised of more than two parts. Furthermore, in some embodiments, the decorative accessory may be comprised of only one part. The decorative accessory may include various decorative elements that may be desirable for adding appeal to a hanging light fixture, such as scrolls, swirls, balls or the like. As another example, the decorative accessory may be a rod that is placed around the cord, wire, or chain of the hanging light fixture.

The accessory part 122 may include an attachment mechanism 126 for connecting with accessory part 124. The attachment mechanism 126 may be built-in or separate from the accessory part 122. The attachment mechanism 126 may be any structure suitable for a connection such as, by way of non-limiting examples, an interlocking part, a clasp, a clip, a screw, an adhesive or a magnet. Furthermore, accessory part 124 may include a coordinating attachment mechanism 126 that connects with the attachment mechanism 126 of accessory part 122. The coordinating attachment mechanism 126 may be any coordinating structures suitable for attachments, such as, by way of non-limiting examples, snaps, clips, hook and loop fasteners, male/female compression fasteners, screw and nut, or interlocking parts. In alternative embodiments, the attachment mechanism 126 may be affixed to the accessory parts 122 and 124 only after the accessory parts 122 and 124 have been placed together around the cord 102, such as with, by way of non-limiting examples, a shrink wrap sleeve or shrink wrap tape.

According to some embodiments, a top connector 118 and a bottom connector 120 are utilized to secure the accessory parts 122 and 124 together around the cord 102. The top connector 118 and the bottom connector 120 are disposed on the cord 102, between the ceiling medallion 108 and the socket 110. As shown in FIG. 1B, the top connector 118 can slide along the length of cord 102 as necessary. The top connector 118 and the bottom connector 120 may be used in conjunction with or instead of attachment mechanism 126 to secure the accessory parts 122 and 124 together around the cord 102.

The top connector 118 is positioned above the accessory parts 122 and 124 while they are put in place. The lower ends of accessory parts 122 and 124 may rest on or within bottom connector 120. In some embodiments, the top connector 118 and the bottom connector 120 may include a magnet, a screw, or some other device to secure the accessory parts 122 and 124 together in place.

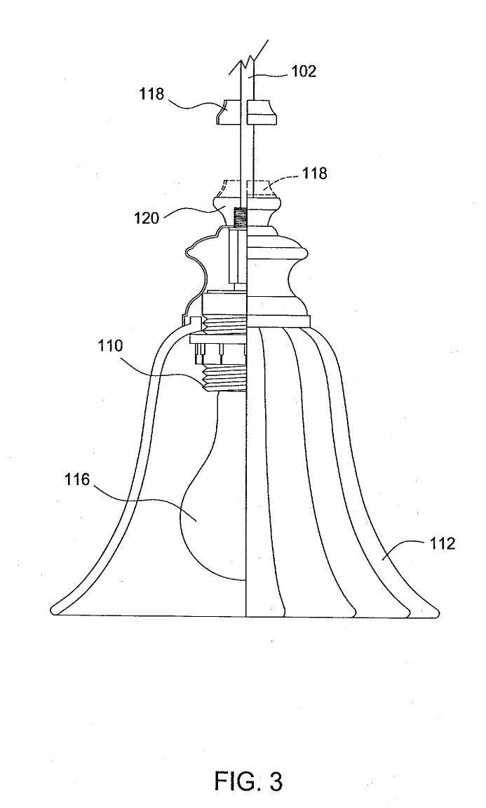

As shown in FIG. 3, the bottom connector 120 may include an inner diameter on its upper surface that substantially matches an outer diameter of the top connector 118. Thus, in certain embodiments, the top connector 118 may partially rest within the bottom connector when the accessory is not attached, providing a finished appearance. As can be seen from FIGS. 1C and 2A, when the accessory parts 122 and 124 have been attached to cord 102, the inner diameter on the upper surface of bottom connector 120 may substantially match an outer diameter of the lower ends of accessory parts 122 and 124. Similarly, the lower surface of the top connector 118 may include an inner diameter that substantially matches an outer diameter of the upper ends of accessory parts 122 and 124. Accordingly, in certain embodiments, the top connector 118, bottom connector 120, and accessory parts 122 and 124 may fit together to provide a finished appearance.

In some embodiments, the accessory may be comprised of more or fewer parts than the two illustrated parts 122 and 124. For example, the accessory may be comprised of one assembly that can be placed and affixed around the cord 102 without removing the light fixture from its finished position. The assembly may include, for example, two parts rotatably connected together with a hinge on one side and configured for attachment together on the other side.

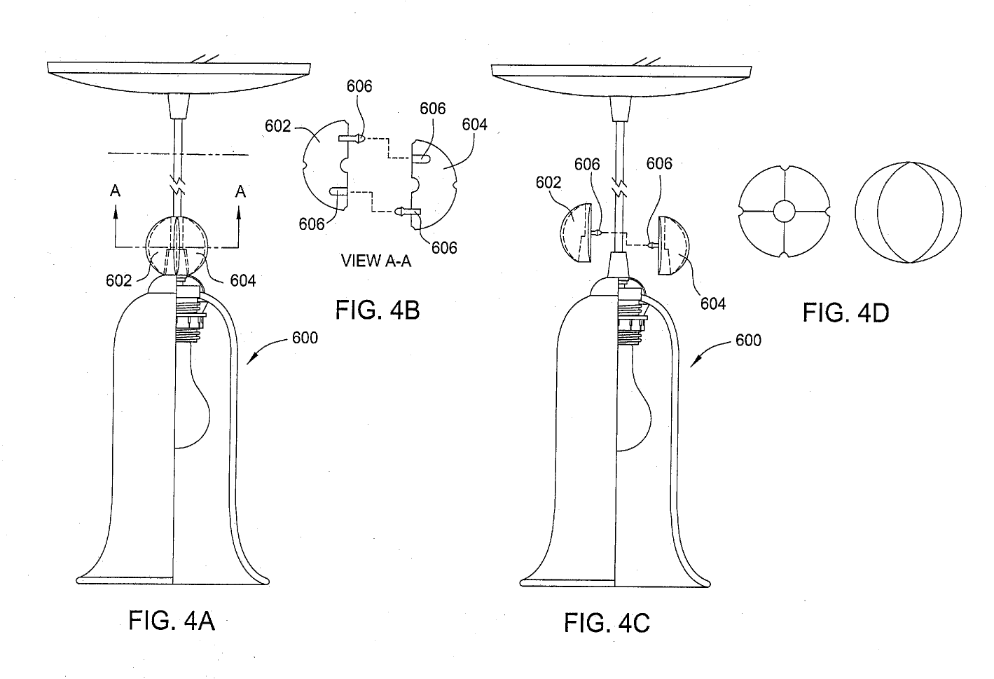

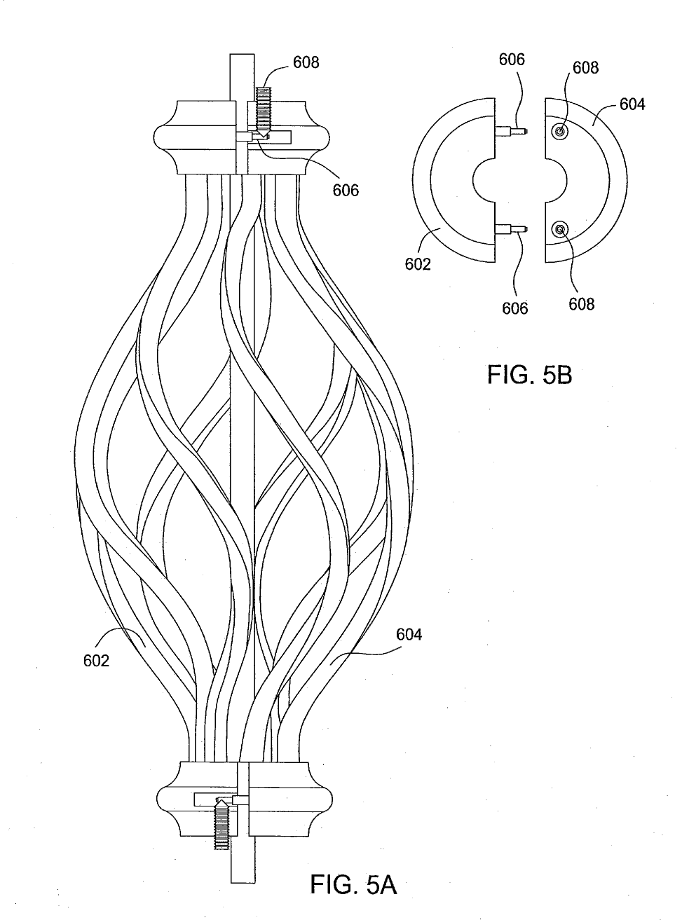

FIGS. 4A-4D and FIGS. 5A-5B illustrate additional embodiments of the present application. In order to add a decorative accessory to an existing lamp that is not specifically configured for such an arrangement, accessory parts 602 and 604 are provided.

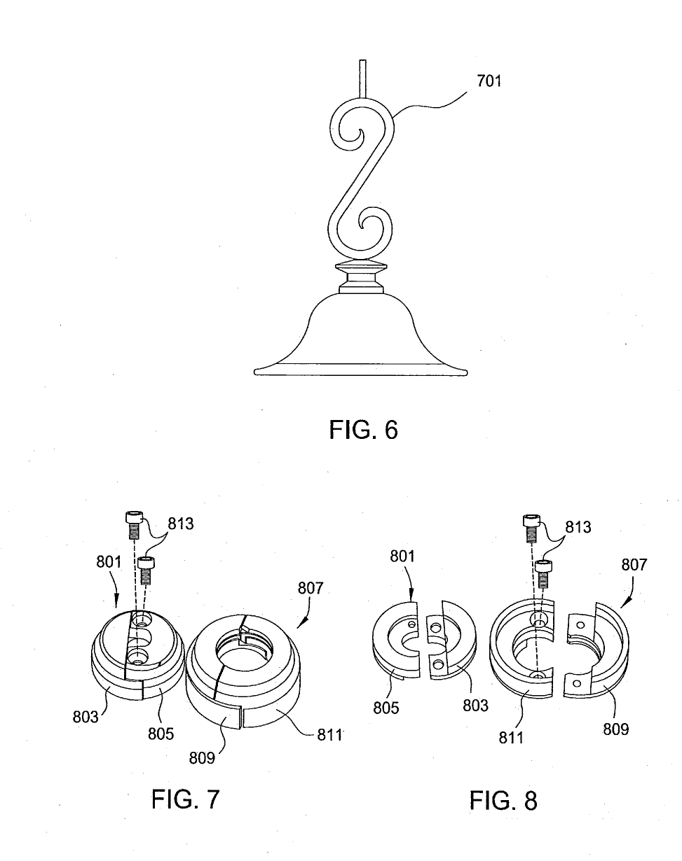

Accessory part 602 may include an attachment mechanism 606 for connecting with accessory part 604. The attachment mechanism 606 may be any structure suitable for a connection such as, by way of non-limiting examples, an interlocking part, a clasp, a clip, a screw, an adhesive or a magnet. Furthermore, accessory part 604 may include a coordinating attachment mechanism 606 that connects with the attachment mechanism 606 of accessory part 604. Coordinating attachment mechanisms 606 may be any coordinating structures suitable for attachments, such as, by way of non-limiting examples, snaps, clips, hook and loop fasteners, male/female compression fasteners, screw and nut, or interlocking parts. In some embodiments, as shown in FIG. 6, accessory part 604 may include one or more screw holes for one or more screws 608 to secure the two accessory parts 602 and 604 together. In alternative embodiments, the attachment mechanism 606 may be affixed to the accessory parts 602 and 604 only after the accessory parts 602 and 604 have been placed together around the cord 102, such as with, by way of non-limiting examples, a shrink wrap sleeve or shrink wrap tape. Other embodiments of attachment mechanisms are described below with respect to FIGS. 6-8.

The attachment mechanism(s) 606 may be disposed on the inside portion of the accessory parts 602 and 604. Thus, in some embodiments, the accessory parts 602 and 604, when placed together around the hanging support member of a hanging light fixture, form an assembly with a finished and/or permanent appearance. In some embodiments, the accessory parts 602 and 604 can be removably secured together around the hanging support member of a hanging light fixture, so that new decorative accessory parts 602 and 604 can be attached to the hanging light fixture according to seasonal or design trends. Accordingly, as set forth above, accessory parts 602 and 604, with attachment mechanism(s) 606, provide for an easy, inexpensive way to add decorative elements to any existing hanging light fixture.

FIG. 6 illustrates another embodiment of the present application. The decorative accessory may provide a non-linear shape to the cord, wire or chain of the hanging light fixture. By way of non-limiting example, the shape provided to the cord wire or chain by the hanging light fixture may be a scroll or ‘S’ shape 701, as shown in FIG. 6. Two or more coordinating parts form the decorative accessory. The cord, wire or chain of the hanging light fixture can be placed inside one part of the decorative accessory and into the rigid shape provided. Then, the other part of the decorative accessory can be connected to the first part of the decorative accessory, In this manner, the cord, wire or chain is secured into a decorative, non-linear hanging position without having remove any portion of the hanging light fixture from its mounted, finished position.

FIGS. 7 and 8 illustrate another embodiment of the present application. Top ring 801 and bottom ring 807 are provided. In FIG. 8, top ring 801 is shown in its upright position, i.e., the same orientation that top ring 801 may have when disposed on a cord, wire or chain of a hanging light fixture. Also, in FIG. 8, bottom ring 807 is shown in an inverted position, i.e., the opposite orientation that bottom ring 807 may have when disposed on a cord, wire or chain of a hanging light fixture.

Top ring 801 may be comprised of two coordinating parts 803 and 805. The two coordinating parts 803 and 805 may be secured together in a known matter, such as with screws 813. The screws or other attachment mechanisms may be disposed on the top of top ring 801 so that the bottom of top ring 801 has a more finished appearance. The bottom ring 807 may be comprised of two coordinating parts 809 and 811. The two coordinating parts 809 and 811 may be secured together in a known matter, such as with screws 813. The screws or other attachment mechanisms may be disposed on the bottom of top ring 80 so that the bottom of top ring 801 has a more finished appearance.

With the foregoing arrangement, a decorative accessory may be added to an existing hanging light fixture by securing the top ring 801 and bottom ring 807 around the cord, wire or chain. Coordinating parts of a decorative accessory may be placed together around the cord, wire or chain of the hanging light fixture, between top ring 801 and bottom ring 807. Similar to the arrangement described above with respect to FIG. 3, the top ring 801 and bottom ring 807 may secure the coordinating parts of the decorative accessory in place around the cord, wire or chain. Accordingly, top ring 801 and bottom ring 807 provide for an easy, inexpensive way to add decorative accessories to any existing hanging light fixture. Alternatively, the top ring 801 or bottom ring 807 could be used as a “stand-alone” decorative accessory for the hanging light fixture.

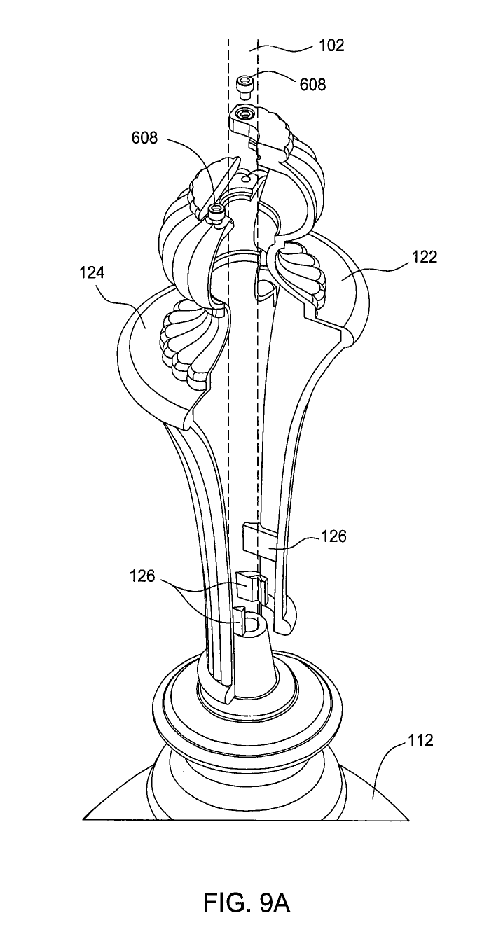

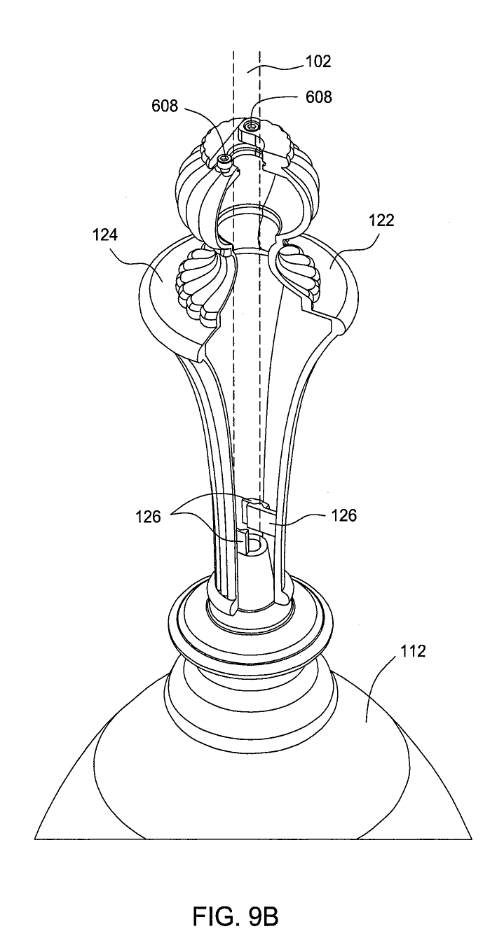

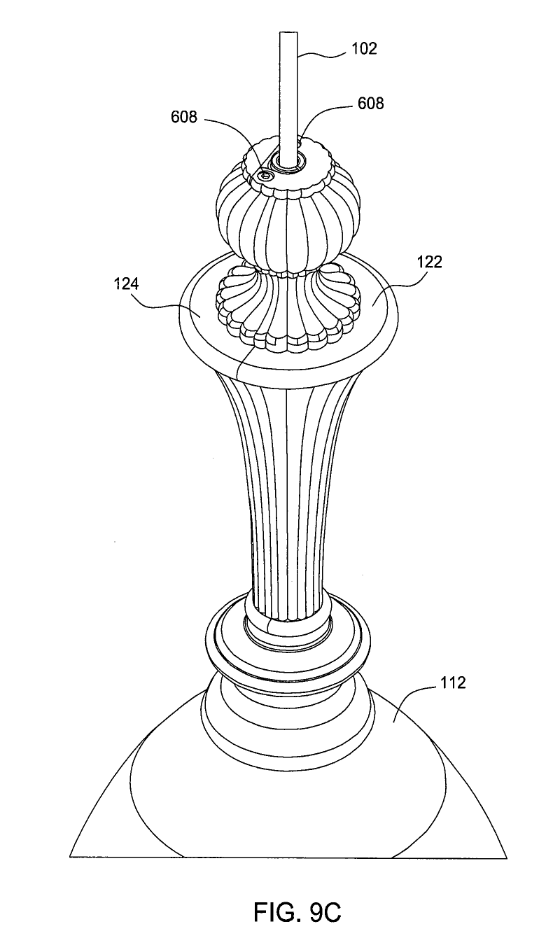

In FIGS. 9A-9C, another embodiment of the present application is illustrated. In FIG. 9A, accessory parts 122 and 124 are positioned around the hanging support member 102 (shown in phantom in FIGS. 9A and 9B). In FIGS. 9A and 9B, accessory part 122 is shown in a partially cut-away view, to illustrate the attachment mechanisms 126. While two accessory parts 122 and 124 are shown, as explained above, some embodiments may include fewer than two or more than two accessory parts. For example, a single assembly may be configured to be disposed around the hanging support member without disassembling any portion of the hanging light fixture or any part of the assembly. As another example, three or more accessory parts may be configured to be disposed around the hanging support member without disassembling any portion of the hanging light fixture or any part of the assembly.

Coordinating attachment mechanisms 126 are provided on each of accessory parts 122 and 124, respectively. The coordinating attachment mechanisms 126 are configured to removably interlock together when the accessory parts 122 and 124 are positioned together, thereby securing the accessory parts 122 and 124 together. Screws 608 may also further secure the accessory parts 122 and 124 together. While screw 608 further secures accessory parts 122 and 124 together, in some embodiments, coordinating attachment mechanisms are sufficient to secure the accessory parts 122 and 124 together in place around the hanging support member without screw 608.

Accordingly, an accessory with a finished appearance, as illustrated in FIG. 9C, may be easily and conveniently added to the hanging support member 102 of the hanging light fixture, without having to thread any portion of the hanging light fixture through the accessory and without disassembling any portion of the hanging light fixture.

While the foregoing is directed to embodiments of the present invention, other and further embodiments of the invention may be devised without departing from the basic scope thereof, and the scope thereof is determined by the claims that follow.

1. An accessory for a hanging light fixture having a hanging support member comprising:
at least a first part and a second part of a decorative accessory, wherein the at least the first part and the second part are configured for placement together around a hanging support member of a hanging light fixture without having to thread the hanging support member through the decorative accessory;
at least one attachment mechanism configured to secure the at least the first part and the second part together around the hanging support member.

2. The accessory of claim 1 further comprising a screw configured to further secure the first part to the second part.

3. The accessory of claim 1 wherein the at least one attachment mechanism includes at least one of: an interlocking part, a clasp, a clip, a screw, an adhesive or a magnet.

4. The accessory of claim 1 wherein the at least one attachment mechanism comprises a first coordinating structure affixed to the first part and a second coordinating structure affixed to the second part, the first coordinating structure and the second coordinating structure forming a coordinating pair, the coordinating pair comprising one of: snaps, clips, hook and loop fasteners, male/female compression fasteners, screw and nut, or interlocking parts.

5. The accessory of claim 1 wherein the at least one attachment mechanism is configured to removably secure the at least the first part and the second part together around the hanging support member.

6. The accessory of claim 1 wherein the at least the first part and the second part, when secured together around the hanging support member, form a rod.

7. The accessory of claim 1 wherein the at least the first part and the second part, when secured together around the hanging support member, form a rigid shape through which the hanging support member passes and causes the hanging support member to assume the rigid shape.

8. The accessory of claim 1 wherein the first part comprises a first half and the second part comprises a second half.

9. The accessory of claim 1 wherein the at least the first part and the second part comprise at least a first part, a second part and a third part.

10. A method for decorating an existing hanging light fixture suspended from a ceiling comprising:
positioning a decorative accessory around a hanging support member of the hanging light fixture while the hanging light fixture remains suspended from the ceiling by the hanging support member; and
securing the decorative accessory around the hanging support member with at least one attachment mechanism.

11. The method of claim 10 wherein the decorative accessory is comprised of two interconnecting halves.

12. The method of claim 10 wherein the hanging light fixture is specially adapted to hold the decorative accessory.

13. The method of claim 10 further comprising attaching the decorative accessory to the hanging support member without threading the hanging support member through the decorative accessory.

14. The method of claim 10 wherein securing the decorative accessory around the hanging support member with at least one attachment mechanism further comprises removably securing at least two parts of the decorative accessory around the hanging support member with at least one attachment mechanism.

15. The method of claim 14 further comprising removably securing the at least two parts of the decorative accessory together with a screw.

16. An accessory for a hanging light fixture having a hanging support member providing an electrical connection to a light socket, the light socket hanging from a lower end of the hanging support member while an upper end of the hanging support member is attached to a ceiling, the accessory comprising:
an assembly configured to be removably disposed around the hanging support member without disassembling any portion of the hanging light fixture; and
a top connection piece configured to be disposed around the hanging support member and configured to removably secure the assembly around the hanging support member without disassembling any portion of the hanging light fixture.

17. The accessory of claim 16 wherein the top connection piece is further configured to removably secure a top portion of the assembly around the hanging support member.

18. The accessory of claim 17 wherein the accessory further comprises a bottom connection piece configured to removably secure a bottom portion of the assembly around the hanging support member.

19. The accessory of claim 16 wherein the top connection piece comprises a first interlocking portion and a second interlocking portion, wherein the first interlocking portion and the second interlocking portion are configured to be removably secured together with a screw.

20. The accessory of claim 19 wherein the first interlocking piece and the second interlocking piece form a ring when removably secured together.
